(19) United States
(12) Patent Application Publication
(10) Pub. No.: US 2013/0259275 A1
(43) Pub. Date: Oct. 3, 2013

(54) Stereo MP3 System

(71) Applicant: Pradeep Ramdeo, Bronx, NY (US)

(72) Inventor: Pradeep Ramdeo, Bronx, NY (US)

(21) Appl. No.: 13/432,019

(22) Filed: Mar. 28, 2012

(51) Int. Cl. G06F 17/00; H04B 7/185; H04R 5/02

(52) U.S. Cl. 381/300; 700/94; 455/12.1

(57) ABSTRACT

A stereo system for listening to music and other content is provided. The stereo system comprises a stereo and an MP3 device mounted within the stereo. The MP3 device stores and plays downloaded MP3 and other digital audio files while also providing full connectivity and compatibility wired or wireless with other devices.

### BACKGROUND OF THE INVENTION

1. Field of the Invention

This invention relates generally to a stereo MP3 system and, more particularly, the invention relates to a stereo MP3 system providing the home stereo with the capability to store and play a virtually unlimited number of downloaded digital audio files MP3's and the likes, also provide full connectivity and compatibility wired or wireless with smart phones, computers, smart TV's and the likes using Wi-Fi, Bluetooth, USB other auxiliary devices, and more.

2. Description of the Prior Art

It is desirable and necessary to upgrade and bring the home stereo system fully into the Digital Age. While so many now enjoy the convenience of the popular, portable, compact MP3 players, devices half the size of a pack of cigarettes, yet able to store thousands of downloaded songs, home stereos remain limited to playing CD's, and the radio. And while it is true that newer systems may be linked to a portable MP3 player via a cable, this solution is rather cumbersome and unwieldy. It would be more desirable and convenient to provide the home stereo with the capability to store and play a virtually unlimited number of downloaded digital audio files.

### SUMMARY

The present invention is a stereo system for listening to music and other content. The stereo system comprises a stereo and an MP3 device mounted within the stereo. The MP3 device stores and plays downloaded MP3 and other digital audio files while also providing full connectivity and compatibility wired or wireless with other devices.

### BRIEF DESCRIPTION OF THE DRAWINGS

FIG. 1 is a perspective view illustrating a stereo MP3 system, constructed in accordance with the present invention;

FIG. 2 is another perspective view illustrating the stereo MP3 system, constructed in accordance with the present invention; and

FIG. 3 is a front elevational view illustrating the stereo MP3 system, constructed in accordance with the present invention.

### DETAILED DESCRIPTION OF THE PREFERRED EMBODIMENTS

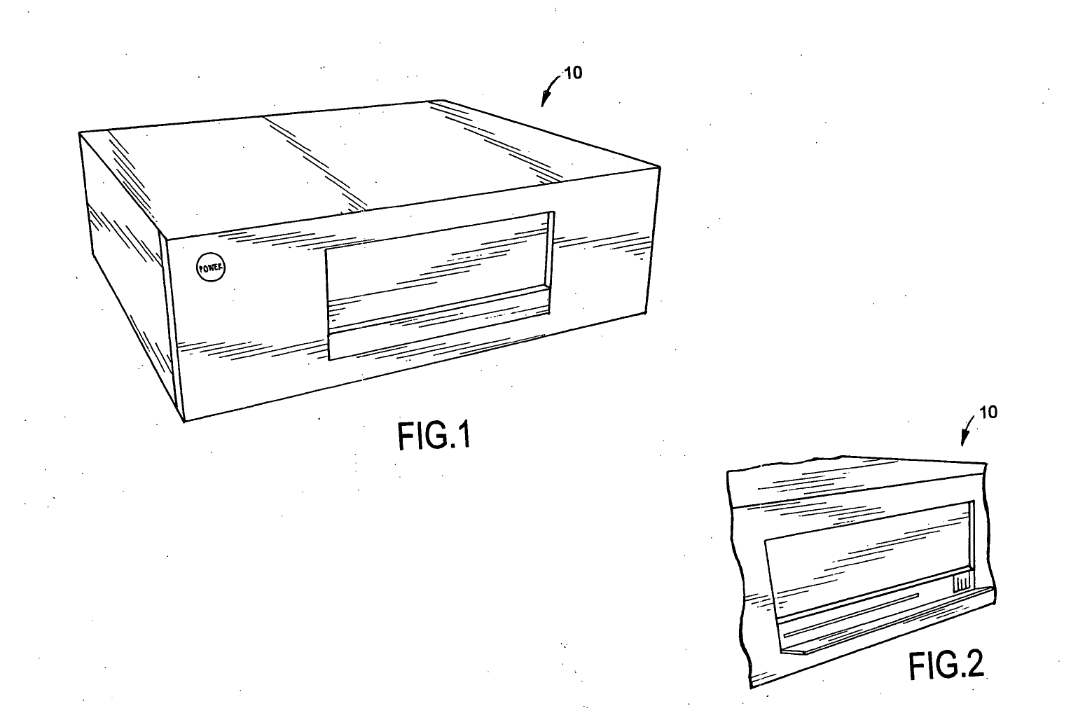

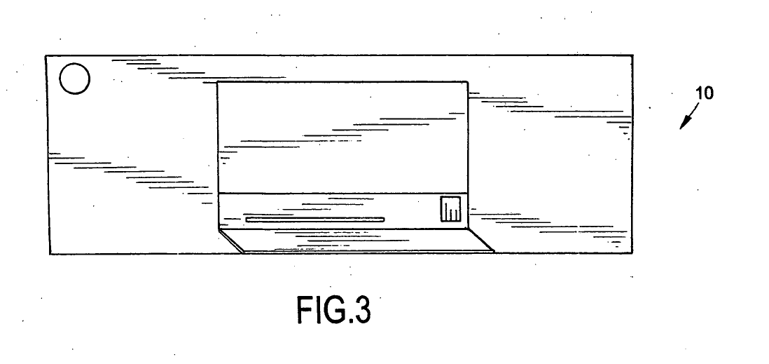

As illustrated in FIGS. 1-3, the present invention is a stereo MP3 system, indicated generally at 10, providing a home stereo with the capability to store and play a virtually unlimited number of downloaded MP3 and other popular digital audio files while also providing full connectivity and compatibility wired or wireless with other devices. The stereo MP3 system 10 of the present invention removes the “Digital Divide” between conventional home stereo systems and the increasingly popular, Internet-based world of downloaded digital audio files like MP3's.

The stereo MP3 system 10 of the present invention is a premium-quality home stereo system, but one equipped with a variety of features providing for full connectivity and compatibility with downloaded digital music files. The stereo MP3 system 10 takes the latest home stereo system and incorporates a [digital] data storage device such as for example a hard drive [hard disk drive], SSD [Solid State Drive], or other data storage devices so that the user can store all of their digital music collection [Mp3 and the likes] on their stereo data storage device The stereo MP3 system 10 can also have a CD player & CD burner, enabling the user to burn downloaded music onto CD's or convert their entire CD collection to MP3's, as well as a USB, [SD] secure data card port and other auxiliary ports. With the stereo MP3 system 10 of the present invention, the user is able to store their entire music collection on the stereo's Data Storage Device by downloading wired or wireless from the portable MP3 player, smart phone, computer, smart TV, and the like via the Internet. The stereo MP3 system 10 can also be equipped with a docking facility for portable MP3 players, extending its capabilities and options even further. The stereo MP3 system 10 can have a modular, three-piece system with a pair of movable speakers accompanying a central base-unit; or it may be offered in both the “component system”, and in a one-piece, portable, boom-box configuration. In each or either case, the stereo MP3 system 10, like other top-quality home and portable systems, offers multiple modes for playback and other functions and features such as for example satellite radio, HD Radio, Internet Radio and [so forth], Wi-Fi, Bluetooth, adjustable bass, treble, fade, and balance; programmable playback settings to select or repeat given songs; Voice recognition/voice command, an LCD or other display panel offering a sequence of function menus as well as a status bar, some models the display panel can be customized, for example, to show graphics, pictures [a screen saver], display the time of day; and so forth.

For most users, the great advantage of the stereo MP3 system 10 of the present invention is its bridging of the current gap between digitally downloaded music which is the domain of MP3 players, computers, tablets and the Internet and the traditional home stereo system. By equipping the stereo MP3 system 10 with a data storage device [hard-drive or other system], the user can download a virtually limitless quantity of MP3-formatted music and other popular digital audio files from either an MP3 player, a computer and so forth, directly into the memory of the stereo. Thus, instead of going through the cumbersome process of connecting an MP3 player to the stereo, one simply accesses the stereo' own memory with the complete library of one's downloaded music, the stereo MP3 system 10 can also be used as a library for other devices, MP3 players, smart phones and so forth which may be able to access stereo MP3 library locally within the house using Bluetooth or from any location using a VPN [Virtual Private Network] or similar type network via the Internet. Because the stereo MP3 system 10 has Wi-Fi and Bluetooth the downloading/uploading [file sharing] to or from may proceeds directly from the Internet, music-sites and etc., via the computer, smart phone [wired or wireless], some models may be able to purchase and download digital files [video or audio] from the Internet without the aid of a computer to stereo mp3's data storage device. Again, the stereo MP3 system 10, equipped with its own CD player & CD burner and an SD port, makes it easy for the user to record downloaded music onto SD Cards, CD's for use in car, trading with friends, and so forth if necessary. The stereo MP3 system 10 can also be equipped with satellite radio compatibility that is activated when the user subscribes to a satellite service. Packed with advanced and up to date features and offered at an affordable price, the stereo MP3 system 10 effectively brings the home stereo into the Digital Age, and combines the best aspects of traditional home stereo systems with the ever-more popular devices used to download, organize, and play music via the Internet.

As technology advances some features of the stereo MP3 system 10 of the present invention can be added, removed, or modify to further improve and update/upkeep Stereo MP3. It is also worth noting that features can vary with each model and not all models may have a CD player and CD burner. Some models may not have a built in data storage device but may use a removable data storage device for example SD card, flash drive, and the like.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein may be suitably practiced in the absence of the specific elements which are disclosed herein.

What is claimed is:

1. A stereo system for listening to music and other content, the stereo system comprising:
a stereo; and
an MP3 device mounted within the stereo;
wherein the MP3 device stores and plays downloaded MP3 and other digital audio files while also providing full connectivity and compatibility wired or wireless with other devices.

2. The stereo system of claim 1 and further comprising:
a digital data storage device mounted within the stereo for storing the digital audio files.

3. The stereo system of claim 2 wherein the digital data storage device is selected from the group consisting of a hard disk drive and a solid state drive.

4. The stereo system of claim 1 and further comprising:
a CD player and a CD burner;
wherein any digital audio file can be transferred to the CD player through the CD burner.

5. The stereo system of claim 4 wherein CD's can be transferred to a digital audio file.

6. The stereo system of claim 1 and further comprising:
a USB player mounted in the stereo.

7. The stereo system of claim 1 and further comprising:
a secure data card port.

8. The stereo system of claim 1 wherein digital audio files can be downloaded to the MP3 either wired or wireless from a portable MP3 player, a smart phone, a computer, or a smart TV via the Internet.

9. The stereo system of claim 1 and further comprising:
a docking facility for portable MP3 players.

10. The stereo system of claim 1 and further comprising:
a modular, three-piece system with a pair of movable speakers accompanying a central base-unit.

11. The stereo system of claim 2 and further comprising:
Wi-Fi and Bluetooth for downloading/uploading [file sharing] to or from the Internet, music-sites and etc., via the computer, smart phone [wired or wireless], for purchasing and download digital files [video or audio] from the Internet without the aid of a computer to the data storage device.

12. The stereo system of claim 1 and further comprising:
satellite radio compatibility activated upon subscription to a satellite service.

13. A stereo system for listening to music and other content, the stereo system comprising:
a stereo;
an MP3 device mounted within the stereo; and
a digital data storage device mounted within the stereo for storing the digital audio files;
wherein the MP3 device stores and plays downloaded MP3 and other digital audio files while also providing full connectivity and compatibility wired or wireless with other devices.

14. The stereo system of claim 13 wherein the digital data storage device is selected from the group consisting of a hard disk drive and a solid state drive.

15. The stereo system of claim 13 and further comprising:
a CD player and a CD burner;
wherein any digital audio file can be transferred to the CD player through the CD burner; and
wherein CD's can be transferred to a digital audio file.

16. The stereo system of claim 13 and further comprising:
a USB player mounted in the stereo.

17. The stereo system of claim 13 and further comprising:
a secure data card port.

18. The stereo system of claim 13 wherein digital audio files can be downloaded to the MP3 either wired or wireless from a portable MP3 player, a smart phone, a computer, or a smart TV via the Internet.

19. The stereo system of claim 13 and further comprising:
a docking facility for portable MP3 players.

20. The stereo system of claim 13 and further comprising:
Wi-Fi and Bluetooth for downloading/uploading [file sharing] to or from the Internet, music-sites and etc., via the computer, smart phone [wired or wireless], for purchasing and download digital files [video or audio] from the Internet without the aid of a computer to the data storage device.
